(19) United States
(12) Patent Application Publication
(10) Pub. No.: US 2007/0203597 A1
(43) Pub. Date: Aug. 30, 2007

(54) Audio data processing apparatus

(75) Inventor: Kentaro Iyoshi, Gyoda-Shi (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Osaka (JP)

(21) Appl. No.: 11/704,517

(22) Filed: Feb. 9, 2007

(30) Foreign Application Priority Data
Feb. 13, 2006 (JP) 2006-35097

(51) Int. Cl. G06F 17/00

(52) U.S. Cl. 700/94

(57) ABSTRACT

A separation unit accepts a digital video and audio signal sent from outside in units of packets and separates the signal into video data and audio data. The audio data separated by this separation unit is written for each packet in an audio data buffer, from which the written audio data is consecutively read out. Moreover, a available capacity determination unit determines a available capacity in the audio data buffer. Based on a result of the determination by this available capacity determination unit, an oscillation frequency of a frequency variable oscillator and the reading at said audio data buffer are controlled.

### CROSS-REFERENCE TO RELATED APPLICATIONS

The entire disclosure of Japanese Patent Application No. 2006-35097 including specifications, claims, drawings, and abstract is incorporated herein by references.

### BACKGROUND

1. Field

The present invention relates to an audio data processing apparatus for processing audio data input from an external source, in consideration of the rate at which the data is transferred (transfer speed).

2. Related Art

Conventionally, wireless transmission systems for transmitting audio and visual (AV) signals haven been known in which television (TV) signals are encoded, transmitting using a wireless LAN, and decoded for playing at a receiver. Such systems typically employ a wireless LAN having a high transmission rate, on the order of 30 Mbps, and transmit TV signal in formats such as NTSC, PAL, or the like.

In such a system, an operation clock itself is typically not transmitted from a sender to the receiver. Therefore, the receiver normally processes the signal transmitted from the sender using an operation clock asynchronous with the operation clock at the sender.

However, if the operation clock at the receiver is not synchronous with the clock of the transmitted signal, an excess or deficiency of data can result, which in turn may cause overflow or underflow of audio data in a buffer for temporarily storing the data. Audio signals are especially sensitive to underflow or overflow because a frame buffer and the like are not provided and a small buffer capacity is preferable.

Attempts have been made to address the above-described problem by compressing (thinning) and outputting partial data in the case of overflow, by outputting the same data twice in the case of the underflow, and the like. In addition, there are also methods of previously including a signal indicating the time in video data, operating a counter based on the signal by the receiver to control the operation clock at the receiver, and the like.

However, these methods are problematic in that sound quality is impaired if data is compressed or repeated. On the other hand, if information for synchronization is inserted in the video signal, there is a problem that demodulation of the signal and operating the counter based on the information for synchronization and the like are required, which increase the size and complexity of the circuit.

### SUMMARY

According to the present invention, a frequency of an operation clock is changed based on a free space (buffer available capacity) in an audio data buffer. Thereby, an appropriate reading speed can be obtained, and overflow or underflow in the audio data buffer can be reliably and efficiently prevented.

### BRIEF EXPLANATION OF DRAWINGS

FIG. 1 shows a general configuration of an apparatus according to an embodiment of the present invention;

FIG. 2 illustrates timings of writing and reading audio data; and

FIG. 3 shows states of a frequency regulation of an operation clock.

### DESCRIPTION OF THE PREFERRED EMBODIMENT

Hereinafter an embodiment of the present invention will be described based on the drawings.

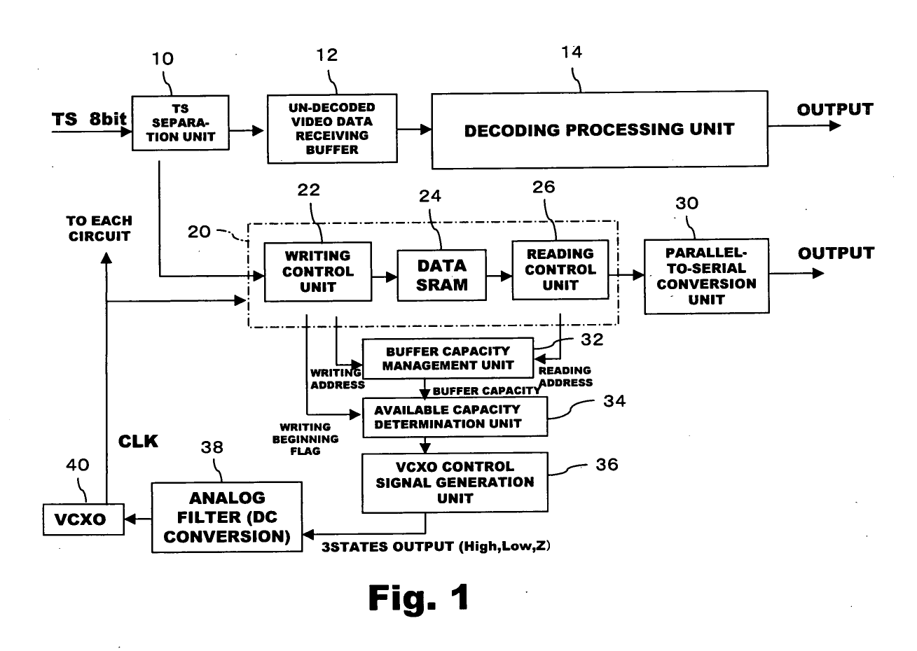

In FIG. 1, a TS signal, which is a coded TV signal, is received by a receiver and supplied to a TS separation unit 10. The TS separation unit 10 separates the supplied 8-bit TS signal into video data and audio data for each packet based on header information in each packet, and the separated video data is supplied to an un-decoded video data buffer 12. This un-decoded video data buffer 12 includes a SRAM for temporarily storing coded video data before being decoded. The video data read out from this un-decoded video data buffer 12 is supplied to a decoding processing unit 14, where the video data is decoded and a predetermined TV signal is output. Here, the data format of the output TV signal may be, for example, the TV signal according to ITU-656, which accommodates both NTSC and PAL TV signals. The signal output by the decoding processing unit 14 is converted into a normal TV video signal and then supplied to a display, on which the content is presented.

Meanwhile, the audio data separated by the TS separation unit 10 is supplied to an audio data buffer 20. The wirelessly transmitted audio data may be, for example, uncompressed 16-bit stereo PCM data. The audio data buffer 20 has a writing control unit 22, and the audio data is written in a data SRAM 24 under the control of the writing control unit 22. This data SRAM 24 is connected to the reading control unit 26, which reads and outputs the data in the data SRAM 24.

The audio data output from the data SRAM 24 under the control of the reading control unit 26 is supplied to a parallel-to-serial conversion unit 30, where the audio data is output as serial data. This serial PCM data is converted into a normal analog audio signal and supplied to a speaker, which outputs the audio content described in the audio data.

Here, the writing control unit 22 and the reading control unit 26 are connected to a buffer capacity management unit 32, to which the writing control unit 22 supplies a writing address and the reading control unit 26 supplies a reading address. Based on the writing address with respect to the data SRAM 24 and the reading address for reading from the data SRAM 24, this buffer capacity management unit 32 detects a free space (available buffer capacity) available for writing in the data SRAM 24.

The buffer capacity management unit 32 is connected to a available capacity determination unit 34, to which the buffer capacity detected by the buffer capacity management unit 32 is supplied. Depending on the available buffer capacity, the buffer capacity determination unit 34 generates a VCXO control signal. This VCXO control signal is supplied to a voltage controlled crystal oscillator (VCXO) 40 via an analog filter 38, and an oscillation frequency of the VCXO 40 is controlled.

An operation clock CLK output by this VCXO 40 is used at least for generating a reading clock of the reading control unit 26, and in this case, used for various operations including a writing clock of the writing control unit 22. In other words, the entire circuit shown in FIG. 1 operates based on the operation clock CLK output by the VCXO 40.

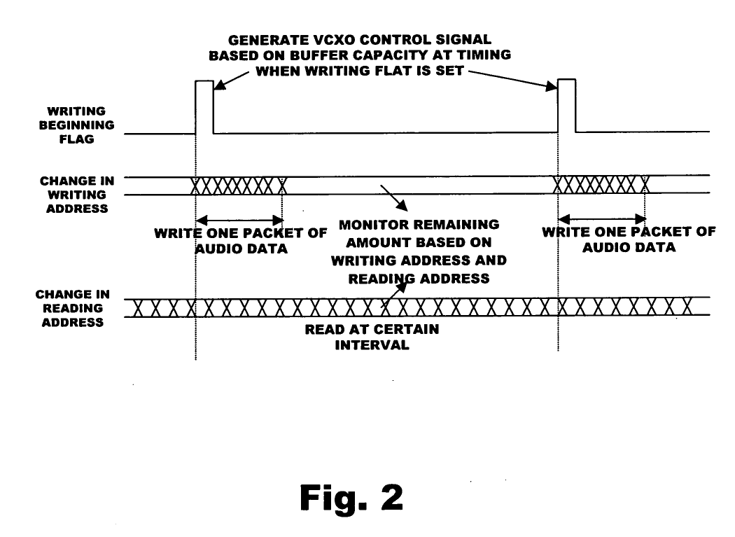

Here, an operation of writing the audio data in the data SRAM 24 will be described based on FIG. 2. Since the TS signal is transmitted in packets each having a predetermined capacity, the audio data is also supplied in units of packets from the TS separation unit 10. The writing control unit 22 sequentially writes one packet of the audio data in the data SRAM 24. When the writing control unit 22 begins the writing, it generates a writing beginning flag and supplies the flag to the available capacity determination unit 34.

The writing control unit 22 writes one packet of the audio data in the data SRAM 24, according to a normal writing clock. Meanwhile, the reading control unit 26 reads the audio data based on the reading clock made to match a playing speed obtained when the audio data is analog-converted. Therefore, as shown in FIG. 2, one packet of the audio data is written in the data SRAM 24 in a relatively short period of time. Thus, the writing address intermittently proceeds only for a predetermined period after the writing has been started. Meanwhile, the reading address consecutively proceeds at a certain speed. Then, the buffer capacity management unit 32 writes the audio data at a timing when the writing beginning flag is output, and compares the reading address to detect the available buffer capacity. Therefore, the available buffer capacity corresponds to the remaining amount immediately before one packet of the audio data is written. A timing of detecting the available buffer capacity may be any timing if each detection has the same condition, and may be another timing. For example, the timing of detecting the available buffer capacity may be a timing after a predetermined time has elapsed after the timing of beginning the writing. Furthermore, multiple writing starts may be counted and the available buffer capacity may be detected once for every specified number of starts. Thereby, it is possible to absorb effects of shifts in the timing of writing caused by a fluctuations in the transmission system and the like.

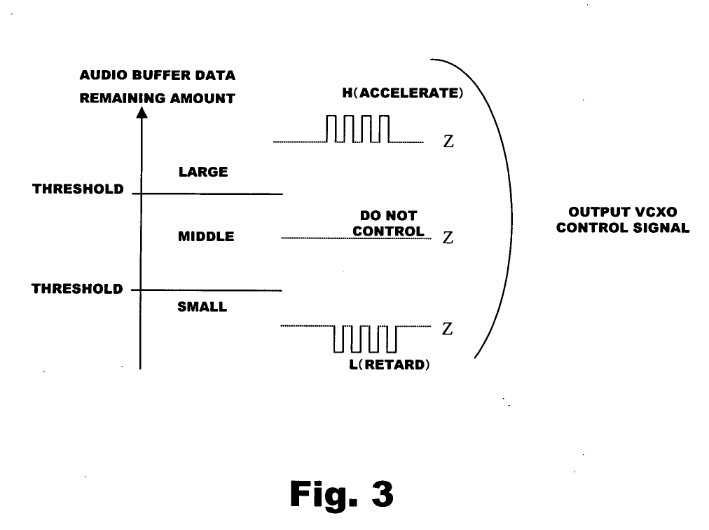

Next, available capacity determination in the available capacity determination unit 34 and a signal generation in a VCXO control signal generation unit 36 will be described based on FIG. 3. The available capacity determination unit 34 prepares two thresholds and determines among three statuses, a large available capacity, a middle available capacity, or a small available capacity. The VCXO control signal generation unit generates a predetermined number of positive pulses when a large capacity is available, generates a predetermined number of negative pulses when a small capacity is available, and maintains a state of high impedance Z when the available capacity is in the middle remaining amount. The VCXO control signal is supplied to the analog filter 38, where the VCXO control signal is integrated and turned into a direct current voltage. In other words, if the positive pulses are output as the VCXO control signal, an output voltage of the analog filter 38 becomes high, and if the negative pulses are output as the VCXO control signal, the output voltage of the analog filter 38 becomes low. The output voltage of the analog filter 38 is supplied to the VCXO 40 as the control signal for its oscillation frequency, so that if the data SRAM 24 has the small available buffer capacity, the operation clock as the output of the VCXO 40 is controlled to become slow and the available buffer capacity is controlled to become large, and if the data SRAM 24 has the large available buffer capacity, the operation clock as the output of the VCXO 40 is controlled to become fast and the available buffer capacity is controlled to become small.

Therefore, overflow (a state where the data cannot be written due to shortage of capacity) or underflow (a state where written data is lost and readout data is lost) can both be prevented from occurring in the data SRAM 24. Particularly, because in this configuration the oscillation frequency of the VCXO 40 is controlled depending on the available buffer capacity in the data SRAM 24, overflow and underflow in the audio data buffer 20 can both be prevented with a very simple configuration, without requiring that the operation clock be controlled by counting an interval between frame beginning signals included in the video signal and the like.

What is claimed is:

1. An audio data processing apparatus comprising:
a separation unit for accepting a digital video and audio signal sent from outside in units of packets and separating the signal into video data and audio data;
an audio data buffer in which the audio data separated by this separation unit is written for each packet and the written audio data is consecutively read out;
a available capacity determination unit for determining the available capacity in the audio data buffer;
an oscillation control signal generation unit for outputting an oscillation control signal based on a result of the determination by this available capacity determination unit; and
a frequency variable oscillator in which an oscillation frequency is controlled based on this oscillation control signal and from which an operation clock is output,
wherein the reading of the audio data from the audio data buffer is controlled by the operation clock output by the frequency variable oscillator.

2. The apparatus according to claim 1, wherein the available capacity determination unit determines the available capacity in synchronization with a timing of writing the audio data separated by the separation unit into the audio data buffer.

3. The apparatus according to claim 2, wherein the oscillation control signal generation unit generates the oscillation control signal in response to the result of the determination in the available capacity determination unit.

4. The apparatus according to claim 3, wherein the oscillation control signal generation unit generates the oscillation control signal for changing a frequency of the operation clock to make it larger when it is determined during the determination in the available capacity determination unit that the available capacity is large, or changing the frequency of the operation clock to make it smaller when it is determined in the available capacity determination unit that the available capacity is small.

5. The apparatus according to claim 4, wherein the oscillation control signal generation unit does not generate the oscillation control signal for changing the frequency of the operation clock when the available capacity is in a range determined as a middle amount in the result of the determination in the available capacity determination unit.

6. The apparatus according to claim 2, wherein the available capacity determination unit determines the available capacity once during every interval of writing.
